(19) United States
(12) Patent Application Publication
(10) Pub. No.: US 2002/0097338 A1
(43) Pub. Date: Jul. 25, 2002

(54) Method and associated device for the display of text on a screen of a television receiver

(75) Inventor: Pascal Voyer, Aix En Provence (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.A., Montrouge (FR)

(21) Appl. No.: 10/011,245

(22) Filed: Dec. 6, 2001

(30) Foreign Application Priority Data
Dec. 6, 2000 (FR) 00 15782

(51) Int. Cl. H04N 5/445; H04N 5/50

(52) U.S. Cl. 348/564; 348/569

(57) ABSTRACT

In a method for the display of text on a screen of a television receiver, the digital data representing a received text are decoded to give, first, a list of characters to be displayed including at least one character and a color palette including at least one color, and second, a matrix of pixels associated with the list of characters to be displayed. Each element of the matrix of pixels defines the color of a corresponding point of the screen. To obtain a visual effect on at least one point of the screen, at least one color of the color palette is modified. The display method may be implemented in a television receiver.

### FIELD OF THE INVENTION

The invention relates to a method and an associated device for the display of text on a screen of a television receiver. The present invention is particularly useful for displaying pages of a teletext service as defined in the enhanced teletext specification (ETS) No. 300,706, dated May 1997. More generally, the invention is useful for any type of on-screen display (OSD) such as, for example, the display of information for the management of the operation of the television receiver.

### BACKGROUND OF THE INVENTION

Teletext is an ancillary service of television channels designed for the transmission of written information as a complement to video information. This written information takes the form of pages that are broadcast one after the other, and the entire set of pages of the teletext program is broadcast cyclically. Each page has about 25 rows of 40 to 60 characters. The corresponding data are transmitted line by line, with the contents of a line being transmitted in one or more data packets.

The information to be displayed on the management of the operation of the television receiver includes, for example, information for setting the volume of the receiver, screen contrast, etc. Information of this kind is displayed on the screen in the form of one or more string of characters that are displayed in the form of menus or written text, overlaid, for example, on a video image. This information is transmitted, for example, by a circuit for the management of the operation of the receiver. It is more usually aimed at helping the viewer control operation of the receiver.

Hereinafter, the word “text” will be used in the broad sense to designate any type of text to be displayed on a screen, for example, a teletext page or quite simply a string of characters (comprising one or more characters) of the menu type or any other type.

The digital data transmitted by a television channel or by a circuit for the management of the operation of the receiver may include, for example, character codes to be displayed. The digital data may also include a code of an attribute, namely a piece of information on the formatting to be applied to the characters (e.g., page background color, ink color, font, etc.). Most usually, an attribute has to be applied to all the characters that follow it, up to the next attribute.

A prior art television receiver 10 comprises, according to FIG. 1, a decoder 13, a data memory 14, a read-only memory 15, a computation circuit 16, a display memory 17, display means 18 and a screen 19.

Digital data are received by the decoder 13. Digital data may be given by a station transmitting a teletext program. In this case, a detection and demodulation circuit extracts the data from a video signal that it receives and gives it to the decoder 13. The digital data can also be given by a circuit (not shown) for the management of the operation of the receiver 10.

The digital data received pertains to text and it contains information on the contents of the text, and the attributes of formatting the characters of the text. The digital data are received and decoded by the circuit 13 which extracts therefrom a list of formatted characters to be displayed, with the list being stored in the memory 14.

Each character of the list of characters to be displayed is defined by a character code, an ink color and a background color. The word “character” must be understood in the broad sense. A character can thus be a letter of an alphabet, a geometrical shape or else any other shape. A list of the characters commonly used is defined in the ETS standard. From the digital data received, the decoder 13 also extracts a list of instructions of visual effects to be applied to the characters of the text to be displayed and a color palette. These two items are also memorized in the random-access memory 14.

A visual effect is a modification, on the display screen and in time, of the appearance of a character, a set of characters, a line, a page, etc. The modification may possibly be repetitive but not necessarily so. For example, one effect instruction may be: “make the characters x, y, z flash at a frequency of 3 Hz” or else “erase the character A at the end of 50 seconds”.

The color palette is a table in which each color code has an associated definition of the corresponding color. The color code is, for example, an 8-bit number. The color palette comprises 16 fixed colors defined in the ETS standard. These colors are, for example, white, black, red, blue, yellow, etc. The color palette can also include 16 colors defined by the station transmitting the teletext program, with the definition of these different colors being transmitted at the beginning of the program or even at the beginning of a page. Other standards also set aside 64 colors for the television-receiver manufacturers so that they can create menus and strings of characters to facilitate the control of the receiver by the user.

The read-only memory 15 comprises a table of characters in which each character code has an associated two-color image characteristic of the character, that is, a background color of the image and an ink color. The computation circuit 16 stores information to be displayed in the display memory 17. The information to be displayed is obtained from the table of characters, and the list of characters to be displayed contained in the memory 14. Finally, the display means 18 copies the contents of the display memory 17 on to the screen 19 of the receiver 10 as a function of the color palette.

In a first mode of display, known as character display, which is the oldest and most commonly used mode for teletext applications, the computation circuit 16, for each character to be displayed successively, copies the image associated with the character in the display memory 17, in specifying the color code associated with the ink color and the color code associated with the background color to be used to display this page. As the case may be, if an effect instruction is contained in the memory 14, then the computation circuit 16, as a function of the effect instruction, will partially or completely modify the contents of the display memory 17 pertaining to one or more characters to which this effect is applied. Finally, the display means 18 will permanently read the display memory and copy its contents on the screen 19 as a function of the list of colors of the color palette contained in the memory 14.

In a second mode of display, known as pixel display, the circuit 16, from the list of characters to be displayed and the table of characters, computes a matrix of pixels and stores it in the display memory 17. Each element of the matrix of pixels contains a code of a color defined in the color palette. Furthermore, each element of the matrix has a pixel of the screen 19 corresponding to it. The full matrix thus corresponds to all the formatted characters to be displayed on the screen.

The size of the matrix depends on the number of pixels that can be displayed on the screen 19 of the television receiver 10. This number depends on the size of the screen 19 and its resolution. Namely, the minimal pixel size that the display means 18 are capable of drawing on the screen. The matrix may contain, for example, 1024*768 elements.

The display means 18 of the receiver 10 then read the matrix of pixels memorized in the display memory 17 and then display pixels corresponding to the screen 19, element by element and line by line. In this second mode of display, the information contained in the digital data received and stored in the video memory is no longer defined by characters to be displayed but by dots corresponding to the dots of the display screen.

The advantage of the pixel display mode for the teletext data is that it can be used to display not only text but also images. There is no possibility or there is a very remote possibility of obtaining this result with character display because each character has a predefined and fixed image associated with it. Another advantage of the pixel display mode is that it can be used to exploit the characteristics of fine resolution of the screen to the fullest extent. It is then possible to use much finer and far more attractive images for the characters.

Another advantage of the pixel display mode is that it can be used to plan new visual effects, which are more complex, but are more attractive for the viewer to enhance the information displayed. It is thus possible, for example, to consider more complex animations of strings of characters displayed than those that could be planned earlier (e.g., flashing, translation on the screen, changing of colors, etc.).

FIG. 2a shows an example of part of a matrix of pixels, as stored by the computation circuit 16 in the display memory 17. If the color palette contained in the memory 14 indicates that the color white is associated with the code 0 and that the color black is associated with the code 1, then the display means 18 imprint a black dot on the screen when an element of the matrix is encoded by a 1 and they display a white dot when a pixel of the matrix is encoded by a 0. In the example of FIG. 2a, the viewer can thus see the word “LES” appear on the screen 19 of the television receiver 10, written in black on a white background.

In another example, a flashing instruction at 1 Hz is stored as a complement in the memory 14. Here, the circuit 16 computes a first matrix pixel such as that of FIG. 2a which is immediately displayed on the screen 19. The viewer thus sees the word “LES” on the screen.

Then, after a ½ second period, due to the effect instruction contained in the memory 14, the circuit 16 computes a new matrix of pixels, part of which is shown in FIG. 2b. The new matrix stored in the display memory 17 is immediately copied on the screen 19 as a function of the color palette and the viewer will see the letters “L” and “S” on the screen.

After another ½ second period, the circuit 16 computes a new matrix of pixels having a part such as that of FIG. 2a. The new matrix is immediately copied on the screen as a function of the same color palette and the viewer again sees the word “LES”. The ½ second period used is of course adjusted so that the effect obtained is periodic with a frequency of 1 Hz. Thus, the viewer finally sees the word “LES” appear on the screen 19 with a flashing letter “E”.

The display in pixel model thus highlights the data displayed on the screen of the television receiver, by the application of attractive visual effects to this data. However, such effects are complicated to obtain and, in certain cases, require a relatively lengthy time to appear on the screen.

As we have seen above, it is necessary to modify the matrix of pixels to bring out such effects. For this purpose, the circuits for computing present day receivers such as that of FIG. 1 must necessarily entirely recompute the matrix of pixels because they are incapable of identifying the elements, in a matrix of pixels, that have to be modified when the appearance of a particular character on the screen has to be changed. The time for computing a matrix of pixels is relatively lengthy.

If a 1 Hz flashing is considered, then the matrix of pixels must be computed and displayed on the screen in half a second, and this is possible. On the contrary, if a faster flashing is planned, then the computation circuit 16 and the display means 18 may not be fast enough to build the corresponding matrices of pixels and display them by providing for the desired flashing frequency.

### SUMMARY OF THE INVENTION

In view of the foregoing background, an object of the invention is to implement a new method and provide a new associated device for the display of text on a television receiver screen that can be used to obtain a flashing effect of the displayed data while reducing the computation time needed for the implementation of the effect sought in the pixel display mode.

More generally, another object of the invention is to implement a new method and to provide a new associated device for the display of text on a screen for obtaining, especially but not solely, visual effects on text type data, such as those defined in the ETS 300,706 standard.

These and other objects, advantages and features according to the present invention are provided by a novel method for the display of text on a television receiver screen, with the text being received in the form of digital data containing information on the informational contents of the text and information on the formatting of these contents for display. The digital data received is decoded to give, first, a list of characters to be displayed comprising at least one character, and a color palette comprising at least one color. Secondly, a matrix of pixels associated with the list of characters to be displayed is also provided, with each element of the matrix of pixels defining the color of a corresponding point of the screen.

The method of the invention is characterized in that, to obtain a visual effect on at least one point of the screen, at least one corresponding color of the color palette is modified. To modify one or more colors of the color palette, only one part of the color palette is exchanged with a corresponding part of a palette of effects associated with the color palette. The colors of the color palette may also be modified by blocks of colors. A block of colors is, for example, associated with a visual effect.

Thus, in the invention, it is proposed to carry out a procedure completely different from the one presently employed in the prior art. The invention indeed proposes, when a modification of the visual appearance of at least one pixel of a text displayed on the screen is being planned, to modify the color palette associated with this text instead of recomputing the matrix of pixels pertaining to a change in appearance.

With the method of the invention, the matrix of pixels is computed only once. The implementation of a visual effect is then expressed solely by a modification of the color palette, which is much faster than a recomputation of the matrix of pixels.

According to one embodiment, a corresponding color of the color palette is modified repetitively at predefined time intervals to obtain a visual effect of flashing of a point of the screen. According to another embodiment, one or more colors of the color palette are modified to obtain several visual effects on several points on the screen. To obtain several visual effects on several points, several colors of the color palette may be modified at different time intervals.

According to one mode of implementation, the method of the invention comprises the following steps:

E1: reception of the text in the form of digital data;

E2: decoding the digital data received and storage of a list of characters to be displayed comprising at least one formatted character, a list of effect instructions comprising possibly one effect instruction, and a color palette;

E3: computation of the matrix of pixels from the list of characters to be displayed and from a table of characters, with each character of the list of characters to be displayed being defined in the form of a set of elements of the matrix of pixels;

E4: performance of a test to ascertain that the list of effect instructions comprises an effect instruction. If the test is positive, performance of the following steps E7 to E9:

E7: storage of a palette of effects;

E8: display of the page, which includes E81: display of the matrix of pixels as a function of the color palette, E82: measurement of a predefined period, and E83: exchange of at least one color of the color palette with a corresponding color of the palette of effects, with the steps E82, E83 being performed in parallel with the step E8; and

E9: performance of a test to ascertain that a new page is received, then if the test is positive, performance of a step E1, and if the test is negative, performance of a step E8.

The invention also relates to a television receiver to implement the method described above, which preferably comprises a decoder to receive digital data representing a text to be displayed and extract, from the data, a list of characters to be displayed, a list of effect instructions and an initial color palette. Display means for the display, from a color palette, the contents of a matrix of pixels representing the list of characters to be displayed.

The receiver of the invention also comprises a computation circuit to compute the matrix of pixels from the list of characters to be displayed and a table of characters, and an updating circuit to modify the contents of the color palette as a function of the list of effect instructions. The updating circuit may comprise storage means to store a palette of effects as a function of the effect instructions, and exchange means to exchange at least one color of the color palette with a corresponding color of the palette of effects.

### BRIEF DESCRIPTION OF THE DRAWINGS

The invention will be understood more clearly and other features and advantages shall appear from the following description, made with reference to the appended drawings, of which:

FIG. 1, already described, is a functional diagram of a television receiver according to the prior art;

FIGS. 2a and 2b, which have already been described, represent examples of a matrix of pixels computed by a component of the circuit of FIG. 1;

FIG. 3 is a functional diagram of a television receiver according to the invention;

FIG. 4 is a graph showing an algorithm for implementing a text display method according to the invention;

FIGS. 5 and 6 are examples of part of a matrix of pixels computed by a component of FIG. 3;

FIGS. 7a, 7b, 8a to 8c show the evolution, as a function of time, of part of the contents of a unit of the circuit of FIG. 3; and

FIG. 9 gives a detailed view of the contents of a unit of the circuit of FIG. 3.

### DETAILED DESCRIPTION OF THE PREFERRED EMBODIMENTS

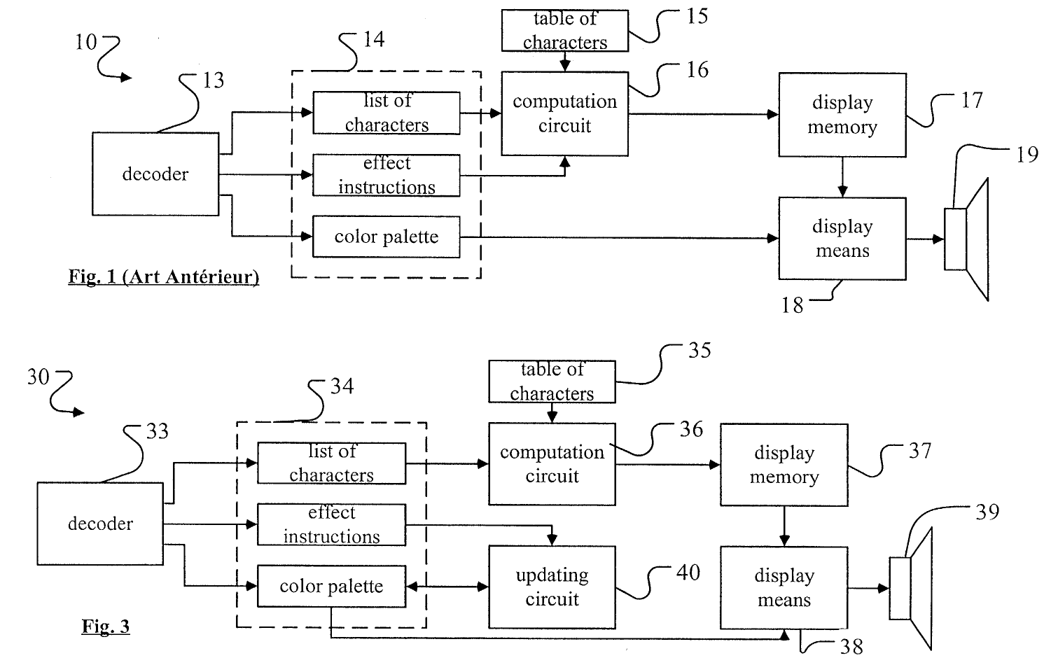

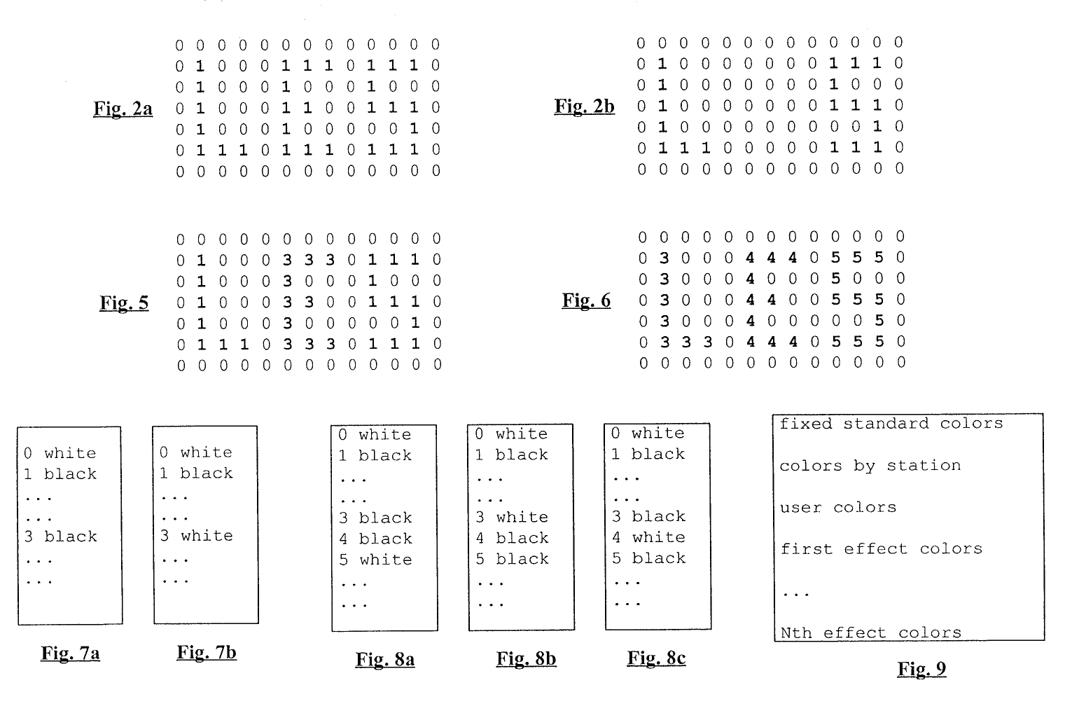

The television receiver 30 according to the invention is shown in FIG. 3. Just like the prior art receiver shown in FIG. 1, the receiver 30 according to the invention comprises a decoder 33, a random-access memory 34, a read-only memory 35, a display memory 37, display means 38 and a screen 39. The units 33 to 35 and 37 to 39 are identical to the corresponding units 13 to 15, 17 to 19 of the circuit of FIG. 1 and they work identically. The memories 34, 35 also comprise the same data elements (list of characters to be displayed, list of effect instructions, color palette and table of characters) as the corresponding memories 14, 15.

The receiver 30 of the invention differs from that of the prior art especially in the following two points. The circuit 16 has been replaced by a new computation circuit 36, and the formatting circuit 40 has been added.

The circuit 36 is connected to the memory 3 to receive the list of characters to be displayed and to the memory 3 to receive the table of characters. Unlike the circuit 16, the circuit 36 is not connected to the memory 34 to receive the list of effect instructions. The circuit 36 computes a matrix of pixels associated with the list of characters to be displayed from the table of characters and it memorizes this matrix in the display memory 37. The computation circuit 36 of the invention does not take account of the list of effect instructions.

The updating circuit 40 is connected to the memory 3 to receive effect instructions. The circuit 40 is also connected to the memory 3 to exchange data with the color palette. The formatting circuit (not shown in detail in FIG. 3) comprises a delay line circuit to measure a period, a random-access memory to memorize a palette of effects and means to exchange all or part of the contents of the color palette with the corresponding contents of the palette of effects as a function of one or more effect instructions as shall be seen more clearly below.

In FIG. 3, the receiver 30 has only one random-access memory 34 to store all the information extracted from the data received. In one variation, this memory 34 may be replaced by several memories to respectively store the list of characters to be displayed, the list of effect instructions and the color palette. It is also possible to replace a part of the memory by a register, for example, to memorize the color palette.

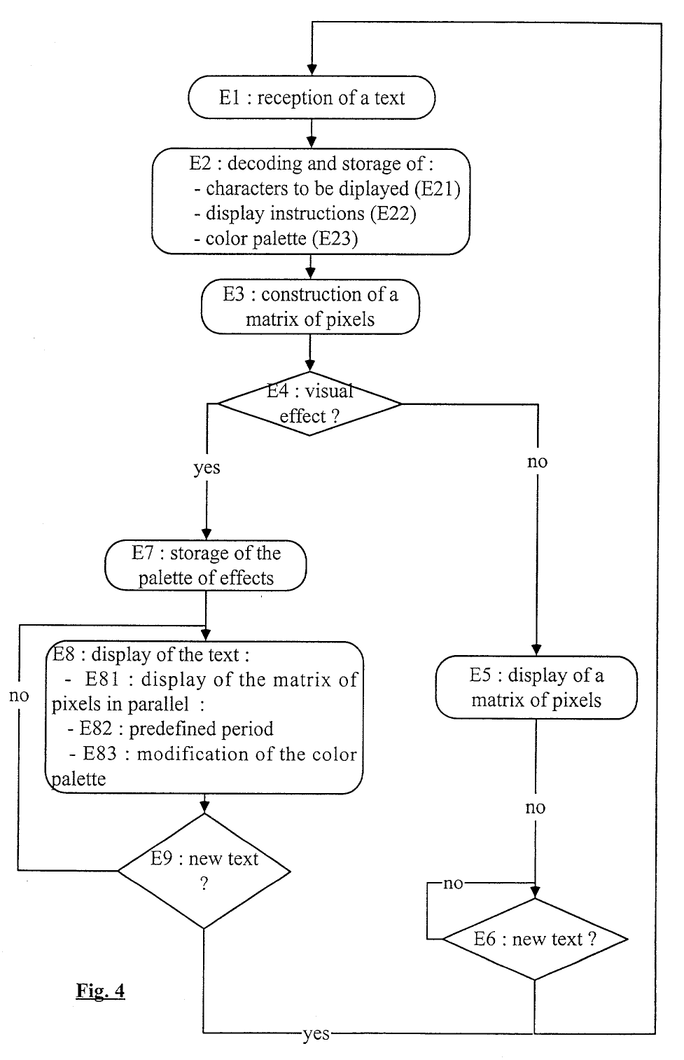

The method of the invention, implemented with the television receiver 30, shall now be described with reference to the diagram of FIG. 4. In a step E1, the digital data pertaining to a text are received by the decoder 33. Herein, the description is limited to the reception of data regardless of its origin. For example, if the origin of the data is a teletext program, the management of the reception of the pages (order, number, etc.) as well as the problems related to the possible storage of these pages are not considered here.

During a step E2, the digital data received are decoded by the decoder 33 which extracts the following information and stores it in the random-access memory 14: a list of characters to be displayed (step E21), a list of effect instructions (step E22), and a color palette (step E23).

As above, the list of characters to be displayed contains a set of characters formatted and defined by a character code, an ink color code and a background color code. The list of instructions, for its part, contains one or more instructions (or none as the case may be) defining one or more visual effects to be applied to all or part of the characters of the list of characters to be displayed. A visual effect is defined, for example, by an instruction of the type: “make the characters x, y, z flash at the frequency of 3 Hz” or else “erase the character A at the end of 50 seconds”.

During a step E3, a matrix of pixels characteristic of the received text is computed by the circuit 36 from the list of characters to be displayed and the table of characters contained in the read-only memory 15. The matrix of pixels is then stored in the display memory 17. Each element of the matrix comprises a color code associated with a color of the color palette. As above, the matrix of pixels defines the color of each pixel of the screen 39.

A test E4 is then performed by the updating circuit 40 to find out whether or not an effect instruction has been memorized in the memory 34. If no effect instruction has been detected, then a display step E5 is performed, wherein the display means 38 copies the contents of the display memory on the screen 39 as a function of the color palette.

Then a second test is performed (step E6) to find out if a new text is sent to the television receiver or not. The expression “next text” must be used here in the broad sense of the term and refers to a text different from the text currently displayed. In particular, an updating of the text currently displayed on the screen 39 is considered here to be a new text. It may also be recalled that the word “text” herein refers to a teletext page sent by a television station or to a string of characters or a menu given by a circuit for the management of the operation of the receiver. If no new text is received (if the step E6 test is negative), then a new step E6 is performed. On the contrary, if a new text has been received by the decoder 33, then a new step E1 is performed.

If, during the step E4, an effect instruction is read in the memory 14, then the following steps E7 to E9 are performed. During the step E7, a palette of effects needed for the implementation of the desired effect is stored in the random-access memory of the circuit 40. Just like the color palette, the palette of effects is a table in which, associated with each color code, there is a definition of the corresponding color. The color codes of the palette of effects are elements of the color palette. On the contrary, the color associated with the color code in the palette of effects may be different from the color associated with the same color code in the color palette. The palette of effects comprises a number of elements smaller than or equal to that of the color palette.

Then, in a step E8, the received text is displayed on the screen 39 in accordance with the desired effect. For this purpose, the display means 38 permanently read the contents of the memory 37 and copies the matrix of pixels on the screen 39 (step E81). At the same time as the step E81, after a period of time measured by the delay line of the circuit 40 (step E82), this circuit 40 exchanges all or part of the contents of the color palette with the corresponding part of the palette of effects (step E83). The duration of the time period (step E82) and the choice of the colors to be changed (step E83) depend on the visual effect (or possibly effects) to be applied.

Finally, a third test (step 39) is performed. If a new text is received by the decoder 33, then a new step E1 is performed. Otherwise, if no new text is transmitted, then a new step E8 is performed. The method according to the invention can be interrupted at any time, i.e., via an external instruction from the user, such as for turning off the program, changing text to be displayed, changing the program, for example.

The different steps of the method of the invention shall now be described in greater detail in examples using different visual effects with reference to FIGS. 5-9.

A first example of a visual effect is the flashing as described above which is implemented simply with the invention. It is assumed here, to simplify the description, that a text is transmitted to the decoder 33 which comprises the characters of the word “LES”. These characters must be displayed in black on a white background and the letter “E”, initially black on a white background must flash at a frequency of 1 Hz. It is assumed finally that the text is not modified in time.

The data are received during the step E1 and then decoded during the step E2. The decoder 33 then stores the following in the memory 34, that is, the list of formatted characters “LES” to be displayed (E21): ink color=black, background color=white; and the list of effect instructions (E22): “make the letter “E” flash at the frequency of 1 Hz”.

The decoder 33 then defines (E23) the list of colors to be used and associates the color code with them as follows. The decoder first of all defines color codes for the colors used for characters whose appearance does not change over time. Here the letters “L” and “S” are permanently displayed in black on a white background. The decoder 33 assigns them the codes: 0=white and 1=black.

The decoder 33 then defines a new color code which will be used for characters whose appearance on the screen changes in the course of time. Here, the letter “E” flashes, and it appears on the screen alternatively, either black on a white background or white on a black background. Furthermore, initially the letter “E” is in black on a white background. Thus, the decoder, for example, defines the code 3 and assigns it the color 3=white. The three codes thus defined form the color palette (FIG. 7a), and is stored in the memory 34.

During the next step E3, the computation circuit 36 builds a matrix of pixels from the list of characters to be displayed and from the table of characters contained in the read-only memory 35. The matrix of pixels obtained is shown in FIG. 5. The elements forming the letters “L” and “S” have the code “1”. The elements of the letter “E” which have to be displayed differently have the code 3, and all the other elements forming the background have the code 0.

The updating circuit 40 then carries out the test E4 and then, if the result is positive, it carries out the step E7 in setting up the palette of effects as follows (FIG. 7b). The elements of the color palette used to display these characters without visual effect are copied identically in the palette of effects, with the codes 0=white and 1=black being copied. The elements of the color palette used to display characters with visual effect are modified. In the example, the code 3=black is replaced by the code 3=white for the letter “E” which must appear alternately black or white.

The palette of effects obtained is stored in the read-only memory of the updating circuit. It is also possible in the palette of effects to store only the codes of the colors used to obtain an effect since the colors used to display characters without effect are not modified. Thus, the memory space needed to store the palette of effects is diminished. If necessary, care will be taken to clearly identify the part of the color palette that must be exchanged with the palette of effects (address of the first color to be changed and/or number of colors to be changed and/or address of the last color to be changed) to carry out the steps E83 properly.

The display step E8 is then carried out. The display means 38 copies the contents of the memory 37 (E81) and the word “LES” appears on the screen 39 in black on a white background because the effects of the matrix of pixels encoded 1 or 3 are displayed in black. In parallel, after a ½ second period of time (E82) needed to obtain flashing at 1 Hz, the updating circuit 40 exchanges (E83) the contents of the color palette with that of the palette of effects and the color associated with the code 3 is changed: 3=white in the color palette and 3=black in the palette of effects. Since the matrix is copied permanently on the screen, the letter “E” disappears from the screen.

Since the text is not refreshed in the course of time, a new step E8 is performed. The code 3 of the color palette is again modified: 3=black in the color palette, with the letter “E” reappearing on the screen. The letter “E” is thus flashed until an external interruption is received.

A second exemplary visual effect is the translation effect, also called the “caterpillar” effect in which the characters of a string of characters are made to flash at the same frequency but where the flashing is staggered in time thus giving an effect of translation of the string of characters on the screen. For the three-letter word “LES”, the following string of characters appears successively on the screen: “LE”, and then “ES”, and then “L S”, and then “LE”, each letter disappearing from the screen in turn during a one-third period.

This effect is implemented with the invention as follows. It is assumed here again that a text is transmitted to the decoder 33 comprising the letters of the word “LES, that the characters have to be displayed in black on a white background and they must furthermore appear with a translation effect at a frequency of 2 Hz (giving a period of a ½ second). Finally, it is assumed that the text is not modified in the course of time.

The data elements are received during the step E1 and then decoded during the step E2. The decoder 33 then stores the following in the memory 34. The list of formatted characters to be displayed (E21): ink color=black, background color=white, and the list of effect instructions (E22): “make the letters ‘LES’ flash at the frequency of 2 Hz with a translation effect”.

The decoder 33 then defines (E23) the list of colors to be used and associates with them a color code (FIG. 8a). The background color and the ink color are herein standard colors of teletext programs. The decoder 33 assigns codes to them: 0=white and 1=black. It must be noted that, in this example, the color black will not be used as a permanent color. Consequently, it could be that the code 1=black will not be defined. The decoder 33 also defines three new color codes, one for each character to be displayed (FIG. 7a): 3=black, 4=black and 5=white. The four codes thus defined form the color palette that is stored in the memory 34.

In the following step E3, the computation circuit 36 builds a matrix of pixels from the list of characters to be displayed and from the table of characters contained in the read-only memory 35. The matrix of pixels obtained is shown in FIG. 6. The elements forming the letter “L” have the code “3”, the elements of the letter “E” have the code “4”, the elements of the letter “S” have the code “5”, and all the other elements forming the background have the code “0”.

The updating circuit 40 then carries out the test E4 and then, and if the result is positive, it performs the test E7 to obtain the palette of effects as follows (FIG. 8b). The elements of the color palette used to display characters without visual effect are copied identically in the effect palette, and the codes 0=white and 1=black are thus copied.

The elements of the color palette used to display characters with visual effect are modified here by circular permutation of the codes. Thus, the code 3=black is replaced by the code 3=white, the code 4=black is replaced by the code 4=black and the code 5=white is replaced by the code 5=black.

The palette of effects (FIG. 8b) obtained is then memorized in the random-access memory of the updating circuit. Here too, it is possible to store, in the palette of effects, only the codes of the colors used to obtain an effect. Thus, the memory space needed to store the palette of effects is reduced.

The display step E8 is then performed. The display means 38 copies the contents of the memory 37 (E81) and the characters “LE” appear on the screen 39 in black on a white background because the elements of the matrix of encoded pixels 3 or 4 are displayed in black and the encoded elements 5 are displayed in white. At the same time, after a period (E82) equal to 0.167 seconds (namely ⅓ of the period, the period being equal to ½ Hz, namely a ½ second), the updating circuit 40 exchanges (E83) the contents of the color palette with that of the palette of effects. Since the matrix is copied out permanently on the screen, the characters “ES” appear on the screen.

An additional step E83′ (not shown in FIG. 4) is then performed. E83′ is the circular permutation of the codes 3 to 5 in the palette of effects. A new palette of effects such as the one shown in FIG. 8c is obtained.

Since the text is not modified in the course of time, a new step E8 is achieved. After a new period of 0.167 seconds (step E82), the codes 3 to 5 of the color palette are once again exchanged (steps E83) with those of the palette of effects. The codes of the color palette are then redefined by 3=black, 4=white, 5=black. The characters “L S” appear on the screen. The codes of the palette of effects are then modified (step E83′) to obtain a palette such as the one shown in FIG. 8a. During the next step E8, the characters “LE” will appear after a new period of 0.167 seconds.

Variations of the method of the invention can easily be planned, especially to obtain visual effects different from those mentioned here above. For example, it is possible to make all the characters of the same string of characters to flash simultaneously. For this purpose, it is sufficient to use the same color code in the matrix of pixels for all the elements of the matrix that correspond to the string of characters.

It will also be possible to obtain a flashing of the character or a string of characters at a frequency different from 1 Hz. For this purpose, it is sufficient to modify the duration of the period during the step E82. It is also possible to erase a string of characters by making it invisible at the end of a time T. For this purpose, it is sufficient to fix a period with a duration T during the first performance of the step E82, and then a very lengthy period during the second performance of the step E82.

Similarly, if two strings of characters have to be displayed with different ink colors, and if these strings of characters have to flash simultaneously, then two new color codes are defined in the color palette and associated with the first color during the step E23. These same color codes are associated with different colors in the palette of effects during the step E7.

It is also possible to make one string of characters flash at a first frequency and another string of characters flash at a second frequency. For this purpose, it is sufficient to assign a first color code to the elements of the first string and a second color code to the elements of the second string. The time period of the step E82 will of course in this case be modified so that the contents of the color palette are modified whenever the color of a pixel on the screen has to change.

Another type of translation effect can also be obtained simply by changing the direction of permutation of the color codes in the palette of effects. Naturally, it is possible to simultaneously total several effects in the same page and/or several effects in the same string of characters. In this case, the steps E82, E83 of the method will have to be modified accordingly.

In a preferred embodiment of the invention, the new color code or codes defined especially to obtain a visual effect are chosen among the color codes not used by the transmitter channels. Indeed, as seen above, 16 colors are fixed, predefined in the ETS standard and common to all the television channels proposing a teletext service. These 16 colors are, for example, stored in advance in the memory 14. These colors are, for example, white, black, red, blue, etc.

Furthermore, there are 16 colors reserved for the transmitter channel of a teletext program. For this purpose, the transmitter channel, for example, at the beginning of a program or at the start of each page, sends a definition of the colors that it chooses to use for the full program of a particular page. These colors defined by the string are stored during the step E23.

Finally, it can also be planned to reserve 64 other colors for the manufacturers of television receivers. If the color codes are encoded on 8 bits, then it is possible to define a total of 2⁸=256 color codes. In this case, when defining new color codes needed for implementing a visual effect, preferably it is the 256-64-32=160 color codes not used by the transmitter channels or the manufacturers of television receivers that are used. Thus, rather than defining the codes 3, 4 or 5 as in the examples of FIGS. 7, 8, it is preferred to use codes higher than 96 in order to prevent any risk of confusion.

It must be noted that the above digital values (number of colors reserved for the television channels and/or the manufacturers of television receivers) are given solely by way of a non-restrictive example of the invention. Other examples can be provided. The standards governing teletext and/or screen displays in general may evolve. In this case, the method of the invention will be adapted accordingly. Furthermore, if the invention is used in a television receiver in which there is no provision for displaying texts or menus by the manufacturers, it is quite possible to use codes greater than 32.

According to another embodiment of the invention, the colors of the color palette and those of the palette of effects are grouped by blocks, as can be seen in FIG. 9. Thus, the 16 fixed colors are grouped in a first block of standard colors. The colors defined by the transmitter station are grouped in a second block of 16 colors. The colors defined by the manufacturer of television receivers are defined in a third block of 64 colors. The colors needed to obtain a first visual effect are grouped in a fourth block. The colors needed to obtain a second visual effect are grouped in a fifth block, etc. Thus, in the steps E83 and/or E83′, only one or the other of the color blocks is really modified. This reduces the duration of these steps.

It is also possible to store, in the palette of effects, only the codes of the colors used in order to achieve an effect. Thus, the memory space needed to store the palette of effects is reduced.

That which is claimed is:

1. A method for the display of text on a screen (39) of a television receiver (30), the text being received in the form of digital data containing information on the informational contents of the text and information on the formatting of these contents for display, the digital data received being decoded to give, firstly, a list of characters to be displayed comprising at least one character, and a color palette comprising at least one color and, secondly, a matrix of pixels associated with the list of characters to be displayed, each element of the matrix of pixels defining the color of a corresponding point of the screen (39),
wherein, to obtain a visual effect on at least one point of the screen, at least one color of the color palette is modified, and to modify one or more colors of the color palette, only one part of the color palette is exchanged with a corresponding part of a palette of effects associated with the color palette.

2. A method according to claim 1 wherein, to obtain a visual effect of flashing of a point of the screen, a corresponding color of the color palette is modified repetitively at predefined time intervals.

3. A method according to claim 1 wherein to obtain several visual effects on several points on the screen (39), one or more colors of the color palette are modified.

4. A method according to claim 3 wherein, to obtain several visual effects at several points, several colors of the color palette are modified at different time intervals.

5. A method according to one of the claims 3 to 5, wherein the colors of the color palette are modified by blocks of colors, each block of colors being associated with its own visual effect.

6. A method according to one of the claims 1 to 6, comprising the following steps:
E1: the reception of the text in the form of digital data,
E2: the decoding of digital data received and the storage of:
a list of characters to be displayed comprising at least one formatted character,
a list of effect instructions comprising possibly one effect instruction, and
a color palette,
E3: the computation of the matrix of pixels from the list of characters to be displayed and from a table of characters, each character of the list of characters to be displayed being defined in the form of a set of elements of the matrix of pixels,
E4: the performance of a test to ascertain that the list of effect instructions comprises an effect instruction and, if the test is positive, the performance of the following steps E7 to E9:
E7: the storage of a palette of effects,
E8: the display of the page:
E81: the display of the matrix of pixels as a function of the color palette,
E82: the measurement of a predefined period,
E83: the exchange of at least one color of the color palette with a corresponding color of the palette of effects, the steps E82, E83 being performed in parallel with the step E8,
E9: the performance of a test to ascertain that a new page is received, then
if the test is positive, the performance of a step E1,
if the test is negative, the performance of a step E8.

7. A television receiver (30) to implement the method described here above, which comprises especially:
a decoder (33) to receive digital data representing a text to be displayed and extract, from said data, a list of characters to be displayed, a list of effect instructions and an initial color palette, and
means (38) for the display, from a color palette, of the contents of a matrix of pixels representing the list of characters to be displayed wherein the receiver also comprises:
a computation circuit (36) to compute the matrix of pixels from the list of characters to be displayed and a table of characters, and
an updating circuit (40) to modify the contents of the color palette as a function of the list of effect instructions, wherein the updating circuit (40) comprises:
storage means to store a palette of effects as a function of the effect instructions, and
exchange means to exchange at least one color of the color palette with a corresponding color of the palette of effects.
